(19) United States
(12) Patent Application Publication
(10) Pub. No.: US 2004/0239611 A1
(43) Pub. Date: Dec. 2, 2004

(54) Double-sided light emitting backlight module

(76) Inventors: Kuo Jui Huang, Chia-Yi Hsien (TW); Yi-Chun Wu, Hualien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/449,022

(22) Filed: Jun. 2, 2003

(51) Int. Cl. G09G 3/36

(52) U.S. Cl. 345/102

(57) ABSTRACT

A double-sided light emitting backlight module is mounted between two liquid crystal display modules and includes at least one light source, a lighting photoconductive board, and at least one brightness enhancement film. Thus, the P light passes through the brightness enhancement film and the S light is reflected by the brightness enhancement film and is transformed to a mixed light of the P light and S light. Thus, the backlight module can prevent the lower polarized plate of the liquid crystal display module from absorbing the S light of all of the light beams of the light source, thereby relatively increasing the usage of the light source, and thereby enhancing the brightness of the liquid crystal display module.

### BACKGROUND OF THE INVENTION

1. Field of the Invention

The present invention relates to a double-sided light emitting backlight module, and more particularly to a double-sided light emitting backlight module that that can achieve a double-sided light emitting effect and can enhance the brightness of the liquid crystal display modules.

2. Description of the Related Art

A conventional liquid crystal display module 3 in accordance with the prior art shown in FIG. 6 comprises a light source 30, a lower polarized plate 11, an upper polarized plate 12, and a liquid crystal layer 13 mounted between the lower polarized plate 11 and the upper polarized plate 12. The light source 30 contains a P light 31 directed toward the P optical axis direction and a S light 32 directed toward the S optical axis direction, wherein the P light 31 is vertical to the S light 32. In addition, the lower polarized plate 11 only allows passage of the P light 31, and the upper polarized plate 12 only allows passage of the S light 32. Thus, after the light beams of the light source 30 passes through the lower polarized plate 11, the S light 32 contained in the light source 30 is absorbed by the lower polarized plate 11, and only the P light 31 contained in the light source 30 passes through the lower polarized plate 11. After the P light 31 passes through the liquid crystal layer 13, the P light 31 is transformed into the S light 32 that can passes through the upper polarized plate 12, so that only half of the optical strength of the light source 30 is effective to the liquid crystal display module 3.

A conventional double-sided light emitting backlight module 4 in accordance with the prior art shown in FIG. 7 comprises a light source 40, and two lighting photoconductive boards 41 and 42 for supplying the light source to two liquid crystal display modules 43 and 44. Each of the two lighting photoconductive boards 41 and 42 has a first side provided with a light outlet face 411 and 421 and a semitransparent reflecting film 45 and 46 and a second side provided with a reflecting plate 47 and 48. Each of the two liquid crystal display modules 43 and 44 is provided with a lower polarized plate 431 and 441. After the light of the light source 40 enters the two lighting photoconductive boards 41 and 42, the light is emitted from the light outlet face 411 and 421 of each of the two lighting photoconductive boards 41 and 42, then passes through the semitransparent reflecting film 45 and 46, and then enters the two liquid crystal display modules 43 and 44. Only the P light contained in the light source 40 can pass through the lower polarized plates 431 and 441 of the two liquid crystal display modules 43 and 44, so that the backlight module 4 only has the P light of the effective light source. Thus, the backlight module 4 needs two lighting photoconductive boards 41 and 42 to achieve a double-sided light emitting effect, thereby increasing the thickness.

Another conventional double-sided light emitting backlight module 5 in accordance with the prior art shown in FIG. 8 comprises a light source 50, and a lighting photoconductive board 51 for supplying the light source to two liquid crystal display modules 54 and 55. The lighting photoconductive board 51 has two light outlet faces 52 and 53 and two semitransparent reflecting films 56 and 57. Each of the two liquid crystal display modules 54 and 55 is provided with a lower polarized plate 541 and 551. After the light of the light source 50 enters the lighting photoconductive board 51, the light is emitted from the light outlet faces 52 and 53 of the lighting photoconductive board 51, then passes through the semitransparent reflecting films 56 and 57, and then enters the two liquid crystal display modules 54 and 55 for supplying the light source to two liquid crystal display modules 54 and 55. Thus, the thickness is reduced. However, only half of the light of the light source 50 is distributed to each of the light outlet faces 52 and 53. In addition, only the P light contained in the light source 50 can pass through the lower polarized plates 541 and 551 of the two liquid crystal display modules 54 and 55, so that the backlight module 5 only has one fourth of the effective light of the light source 50, thereby decreasing the brightness of the liquid crystal display modules.

### SUMMARY OF THE INVENTION

The primary objective of the present invention is to provide a double-sided light emitting backlight module that can achieve a double-sided light emitting effect by the single lighting photoconductive board.

Another objective of the present invention is to provide a double-sided light emitting backlight module that reduce the thickness of the backlight module.

A further objective of the present invention is to provide a double-sided light emitting backlight module that can enhance the brightness of the liquid crystal display modules.

In accordance with the present invention, there is provided a double-sided light emitting backlight module mounted between two liquid crystal display modules, comprising:

at least one light source;

a lighting photoconductive board having a side formed with a light entrance face adjacent to the light source and two parallel faces respectively formed with a first light outlet face and a second light outlet face each adjacent to the light entrance face to respectively provide a light source required by each of the two liquid crystal display modules; and

at least one brightness enhancement film capable of separating two axial lights, so that one axial light passes through the brightness enhancement film and the other axial light is reflected by the brightness enhancement film, the brightness enhancement film being mounted on one of the first light outlet face and the second light outlet face of the lighting photoconductive board, thereby enhancing the brightness of the liquid crystal display modules by the features of the brightness enhancement film.

Further benefits and advantages of the present invention will become apparent after a careful reading of the detailed description with appropriate reference to the accompanying drawings.

### BRIEF DESCRIPTION OF THE DRAWINGS

FIG. 1 is a structural view of the double-sided light emitting backlight module in accordance with the first embodiment of the present invention;

FIG. 2 is a optical travel view of the double-sided light emitting backlight module in accordance with the first embodiment of the present invention;

FIG. 3 is a schematic view of the brightness enhancement film of the double-sided light emitting backlight module in accordance with the first embodiment of the present invention;

FIG. 4 is a structural view of the double-sided light emitting backlight module in accordance with the second embodiment of the present invention;

FIG. 5 is a optical travel view of the double-sided light emitting backlight module in accordance with the second embodiment of the present invention;

FIG. 6 is a perspective view of a conventional liquid crystal display module in accordance with the prior art;

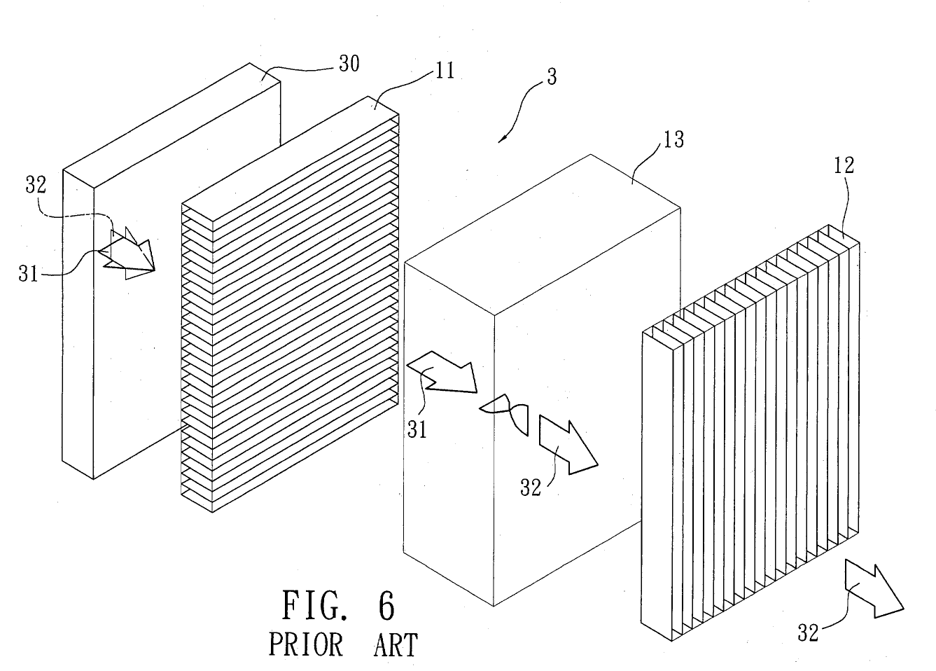

FIG. 7 is a schematic view of a conventional double-sided light emitting backlight module in accordance with the prior art; and

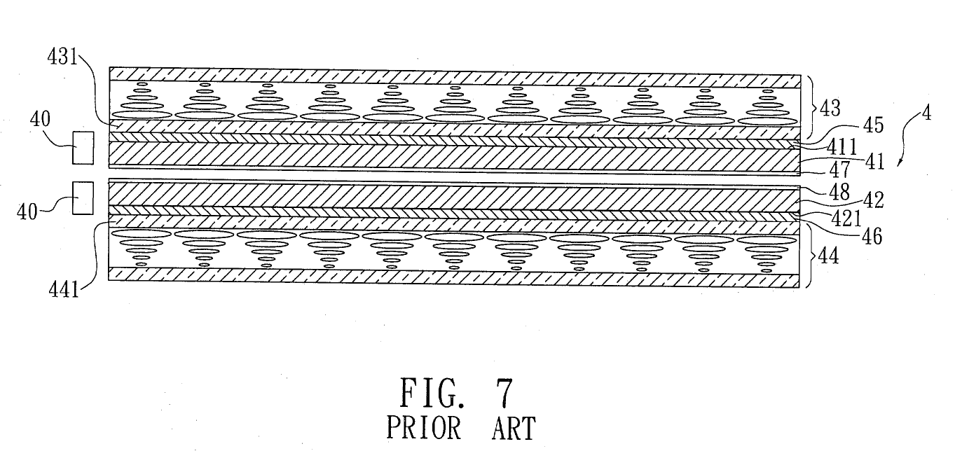

FIG. 8 is a schematic view of another conventional double-sided light emitting backlight module in accordance with the prior art.

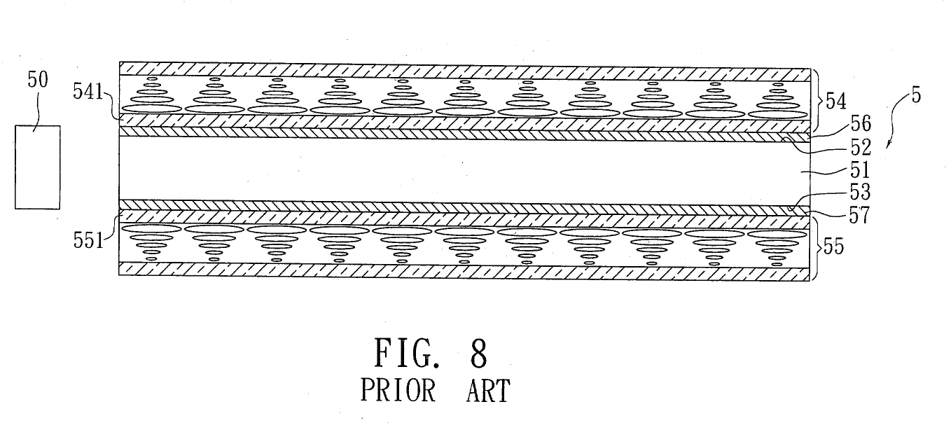

### DETAILED DESCRIPTION OF THE INVENTION

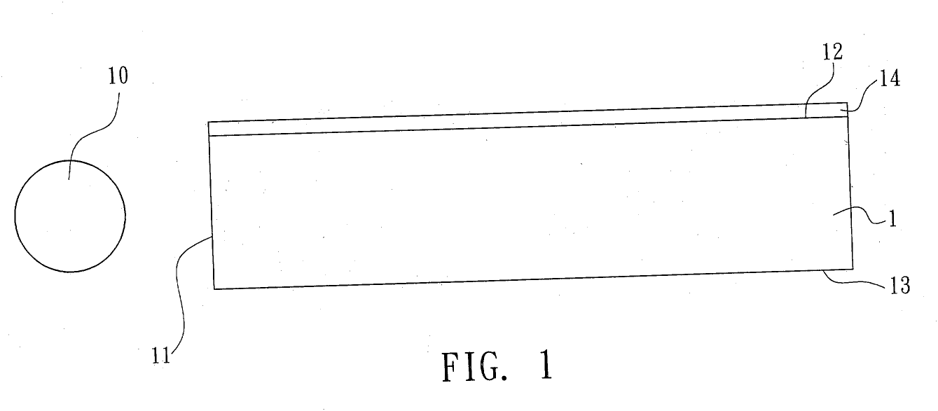

Referring to the drawings and initially to FIGS. 1-3, a double-sided light emitting backlight module in accordance with a first embodiment of the present invention comprises at least one light source 10, a lighting photoconductive board 1, and a brightness enhancement film 14.

In the first embodiment of the present invention, the double-sided light emitting backlight module uses a light source 10.

The lighting photoconductive board 1 has a side formed with a light entrance face 11 adjacent to the light source 10 and two parallel faces respectively formed with a first light outlet face 12 and a second light outlet face 13 each adjacent to the light entrance face 11.

The brightness enhancement film 14 is mounted on a side of the first light outlet face 12. The brightness enhancement film 14 preferably adopts PCF or DBEF (dual brightness enhancement film).

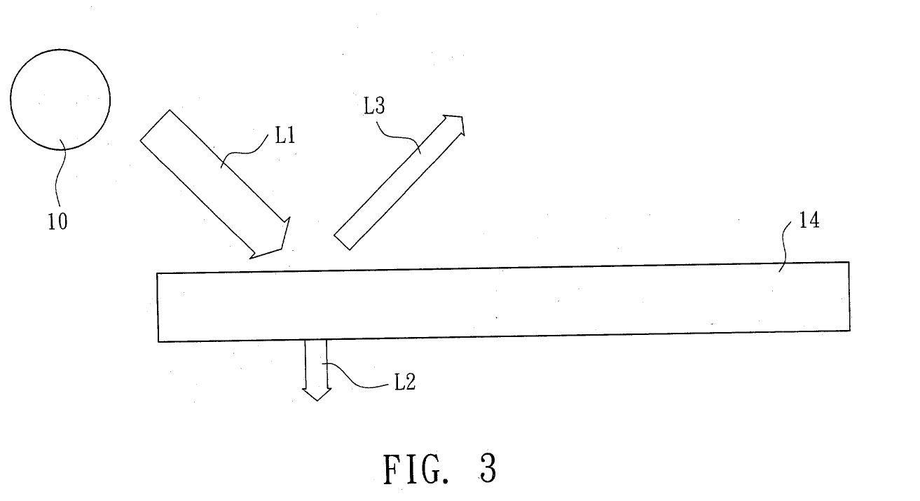

Referring to FIG. 3, the light strength of the light source is indicated by the width of the mark lines. The incidence light L1 (P light and S light) will produce a permeable light L2 (P light) and a reflective light L3 (P light and S light). The brightness enhancement film 14 separates the P light from the S light, so that the P light passes through the brightness enhancement film 14 and the S light is reflected by the brightness enhancement film 14. Thus, in the light source 10, the P light passes and the S light is reflected, while the S light after reflected is transformed to a mixed light of the P light and S light.

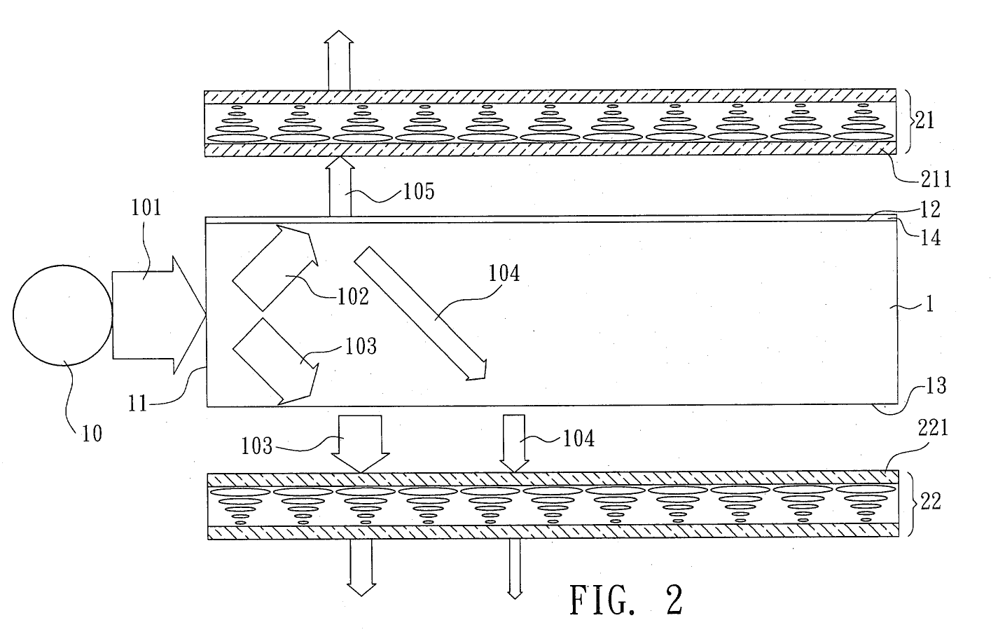

Referring to FIG. 2, the backlight module has two sides respectively provided with liquid crystal display modules 21 and 22 each provided with a lower polarized plate 211 and 221. For illustration, the light strength of the light source is indicated by the width of the mark lines, and only the path of the single light is indicated. In practice, the light beams 101 of the light source 10 includes P light and S light. After the light beams 101 enter the lighting photoconductive board 1 from the light entrance face 11, the incidence lights 102 and 103 of the light beams 101 are projected on the first light outlet face 12 and the second light outlet face 13 respectively. The first light outlet face 12 is provided with the brightness enhancement film 14, so that the incidence light 102 projected on the first light outlet face 12 will produce a first reflective light 104 directed toward the second light outlet face 13 and a first permeable light 105 directed toward the first light outlet face 12. In such a manner, the first reflective light 104 is a mixed light of the P light and S light, and the first permeable light 105 is the P light. The optical axis of the first permeable light 105 has a direction the same as that of the lower polarized plate 211, so that the first permeable light 105 can pass through the lower polarized plate 211 without loss. In addition, the first reflective light 104 is directed toward the second light outlet face 13, so that the light beams emitted from the second light outlet face 13 includes the incidence light 103 and the first reflective light 104, thereby enhancing the brightness of the liquid crystal display module 22.

In conclusion, by the optical feature of the brightness enhancement film 14, the light absorption of the lower polarized plate 211 of the liquid crystal display module 21 provided with the brightness enhancement film 14, and the light that will be absorbed is reflected to the opposite liquid crystal display module 22, thereby enhancing the brightness of the liquid crystal display module 22. Thus, the brightness of the liquid crystal display module 22 is enhanced without decreasing the brightness of the liquid crystal display module 21.

In addition, the lower polarized plate of each of the two liquid crystal display modules only allows passage of the P light, so that the backlight module can transform all of the light beams of the light source into the P light, and can prevent the lower polarized plate of each of the two liquid crystal display modules from absorbing the S light of all of the light beams of the light source, thereby relatively increasing the usage of the light source, and thereby enhancing the brightness of the liquid crystal display module.

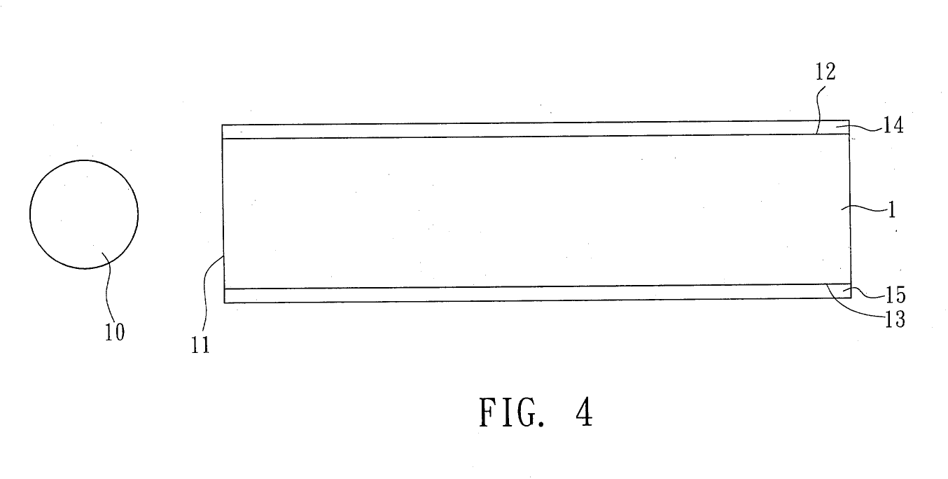

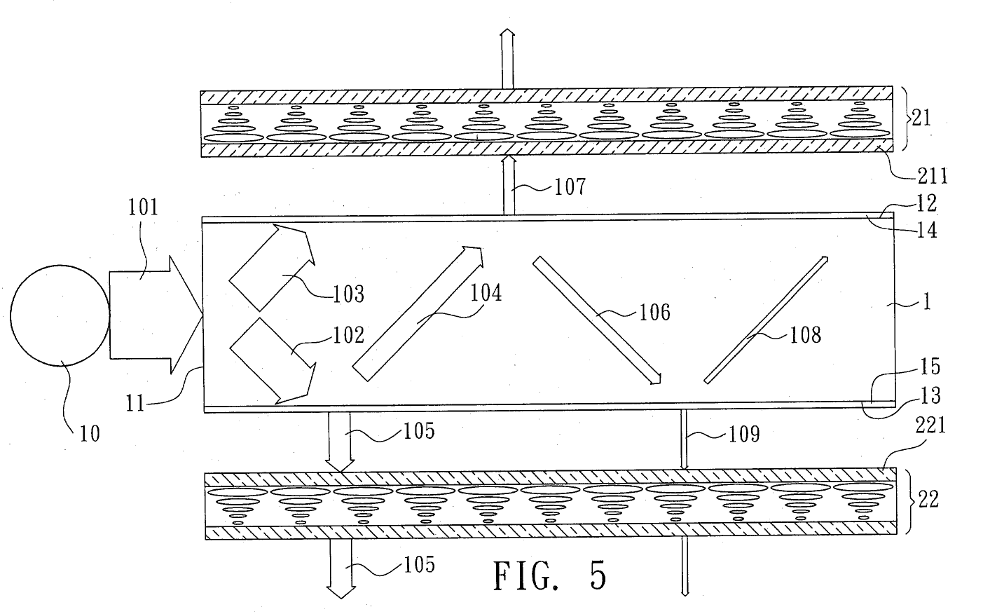

Referring to FIGS. 4 and 5, the double-sided light emitting backlight module in accordance with the second embodiment of the present invention comprises at least one light source 10, a lighting photoconductive board 1, a first brightness enhancement film 14, and a second brightness enhancement film 15.

In the second embodiment of the present invention, the double-sided light emitting backlight module uses a light source 10.

The lighting photoconductive board 1 has a side formed with a light entrance face 11 adjacent to the light source 10 and two parallel faces respectively formed with a first light outlet face 12 and a second light outlet face 13 each adjacent to the light entrance face 11.

The first brightness enhancement film 14 and the second brightness enhancement film 15 are mounted on a side of the first light outlet face 12 and the second light outlet face 13 respectively. Thus, the light beams are reflected between the first brightness enhancement film 14 and the second brightness enhancement film 15 successively, so that all of the light beams of the light source are transformed into a light whose optical axis direction satisfies the two liquid crystal display modules 21 and 22, thereby enhancing the brightness of the liquid crystal display modules.

Referring to FIG. 5, the backlight module has two sides respectively provided with liquid crystal display modules 21 and 22 each provided with a lower polarized plate 211 and 221 adjacent to the first brightness enhancement film 14 and the second brightness enhancement film 15 respectively. In addition, the lower polarized plates 211 and 221 only allows passage of the P light.

For illustration, the light strength of the light source is indicated by the width of the mark lines, and only the path of the single light is indicated. In practice, the light beams 101 of the light source 10 includes P light and S light. After the light beams 101 enter the lighting photoconductive board 1 from the light entrance face 11, the incidence lights 102 and 103 of the light beams 101 are projected on the first light outlet face 12 and the second light outlet face 13 respectively. The second light outlet face 13 is provided with the second brightness enhancement film 15, so that the incidence light 102 projected on the second light outlet face 13 will produce a first reflective light 104 directed toward the first light outlet face 12 and a first permeable light 105 directed toward the second light outlet face 13. In such a manner, the first reflective light 104 is a mixed light of the P light and S light, and the first permeable light 105 is the P light. In addition, the first light outlet face 12 is provided with the first brightness enhancement film 14, so that the first reflective light 104 projected on the first light outlet face 12 will produce a second reflective light 106 directed toward the second light outlet face 13 and a second permeable light 107 directed toward the first light outlet face 12. Further, the second reflective light 106 projected on the second light outlet face 13 will produce a third reflective light 108 directed toward the first light outlet face 12 and a third permeable light 109 directed toward the second light outlet face 13.

In such a manner, the incidence light 102 produces reflective light and permeable light between the first brightness enhancement film 14 and the second brightness enhancement film 15 successively. Similarly, the incidence light 103 also produces reflective light and permeable light between the first brightness enhancement film 14 and the second brightness enhancement film 15 successively. Finally, the reflective light and permeable light are evenly emitted toward the two liquid crystal display modules 21 and 22, and all of the emitted light beams are transformed into the P light.

Thus, the light beams are reflected between the first brightness enhancement film 14 and the second brightness enhancement film 15 successively, so that all of the light beams of the light source are transformed by the backlight module into the P light whose optical axis direction satisfies the lower polarized plates 211 and 221 of the two liquid crystal display modules 21 and 22, to pass through the lower polarized plates 211 and 221 without loss, thereby enhancing the brightness of the liquid crystal display modules.

In conclusion, the lighting photoconductive board 1 is provided with the first brightness enhancement film 14 and the second brightness enhancement film 15, so that all of the light beams of the light source are transformed into the P light. In addition, the lower polarized plates 211 and 221 of the two liquid crystal display modules 21 and 22 only allows passage of the P light to prevent the lower polarized plates 211 and 221 from absorbing the S light in the light source, thereby preventing from incurring the optical loss, so that the two liquid crystal display modules 21 and 22 can achieve the optimum optical efficiency.

Thus, the backlight module can achieve a double-sided light emitting effect by the single lighting photoconductive board 1, reduce the thickness of the backlight module, and can enhance the brightness of the liquid crystal display modules.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A double-sided light emitting backlight module mounted between two liquid crystal display modules, comprising:
at least one light source;
a lighting photoconductive board having a side formed with a light entrance face adjacent to the light source and two parallel faces respectively formed with a first light outlet face and a second light outlet face each adjacent to the light entrance face to respectively provide a light source required by each of the two liquid crystal display modules; and
at least one brightness enhancement film capable of separating two axial lights, so that one axial light passes through the brightness enhancement film and the other axial light is reflected by the brightness enhancement film, the brightness enhancement film being mounted on one of the first light outlet face and the second light outlet face of the lighting photoconductive board, thereby enhancing the brightness of the liquid crystal display modules by the features of the brightness enhancement film.

2. The double-sided light emitting backlight module in accordance with claim 1, wherein the brightness enhancement film is PCF.

3. The double-sided light emitting backlight module in accordance with claim 1, wherein the brightness enhancement film is DBEF.

4. The double-sided light emitting backlight module in accordance with claim 1, wherein the other one of the first light outlet face and the second light outlet face of the lighting photoconductive board is also provided with a brightness enhancement film, so that after the light is reflected between the two brightness enhancement films, all of the light sources are transformed into a light whose optical axis direction satisfies the two liquid crystal display modules, thereby enhancing the brightness of the liquid crystal display modules.

5. The double-sided light emitting backlight module in accordance with claim 4, wherein the brightness enhancement film is PCF.

6. The double-sided light emitting backlight module in accordance with claim 4, wherein the brightness enhancement film is DBEF.
